(19) United States
(12) Patent Application Publication
(10) Pub. No.: US 2025/0357805 A1
(43) Pub. Date: Nov. 20, 2025

(54) NON-UNIFORM FLUX BARRIER SHAPES FOR PERMANENT MAGNET-ASSISTED SYNCHRONOUS RELUCTANCE MOTORS

(71) Applicant: Vitesco Technologies USA, LLC, Auburn Hills, MI (US)

(72) Inventors: Reza Nasirizarandi, Windsor (CA); Mohammad Hossain Mohammadi, Windsor (CA)

(73) Assignee: Vitesco Technologies USA, LLC, Auburn Hills, MI (US)

(21) Appl. No.: 19/088,178

(22) Filed: Mar. 24, 2025

Related U.S. Application Data
(60) Provisional application No. 63/647,281, filed on May 14, 2024.

(51) Int. Cl. H02K 1/276; H02K 1/24; H02K 29/03

(52) U.S. Cl. CPC H02K 1/2766; H02K 1/246; H02K 29/03

(57) ABSTRACT

A permanent magnet-assisted synchronous reluctance motor (PMa SynRM) structure which addresses several challenges in conventional motor designs. By strategically incorporating permanent magnets (PMs) into the motor structure, the PMa SynRM structure of the present invention improves the overall motor performance by achieving increased reluctance-to-permanent magnet torque ratio, decreased torque ripple, reduced dependency on permanent magnets, optimized torque and power characteristics for dominant reluctance torque scenarios by designing for applicable and proper geometric dimensions, material characteristics, and winding layouts, and increased energy efficiency and lower environmental impact.

### CROSS-REFERENCE TO RELATED APPLICATIONS

This application claims the benefit of provisional application 63/647,281, filed May 14, 2024. The disclosure of the above application is incorporated herein by reference.

### FIELD OF THE INVENTION

The invention relates generally to a permanent magnet-assisted synchronous reluctance motor (PMa SynRM) structure which facilitates increased reluctance-to-permanent magnet torque ratio, decreased torque ripple, and optimized torque and power characteristics for dominant reluctance torque scenarios.

### BACKGROUND OF THE INVENTION

Electric motors typically include a rotor surrounded by a stator, where the stator has several coil windings, and the rotor is made up of a stack of laminations, and formed as part of the stack of laminations is a plurality of cavities, which function as flux barriers. The flux barriers may have various shapes. Some of the more commonly known shapes for a flux barrier are a U-shape, U-V shape, or a V-shape. Each of the flux barriers includes a tail portion and a wing portion, which may have varying dimensions.

Disposed in the barriers are permanent magnets (PM), which influence magnetic flux distribution of the electric motor. Various designs have been proposed with regard to different shapes and numbers of barriers, different number of PMs and PM material has also been proposed as a PM assisted synchronous reluctance motor. However, the geometry or the design is not the optimized structure in terms of higher ratio of reluctance-to-PM torque, less torque ripple, and incorporating permanent magnets which do not use rare earth materials.

Accordingly, there exists a need for an electric motor which has flux barriers and PMs, where the shape of the flux barriers and the PMs facilitate increased reluctance-to-permanent magnet torque ratio, decreased torque ripple, and reduced dependency on PMs made of rare earth materials.

### SUMMARY OF THE INVENTION

In an embodiment, the present invention is a permanent magnet-assisted synchronous reluctance motor (PMa SynRM) structure which addresses several challenges in conventional motor designs. By strategically incorporating permanent magnets (PMs) into the motor structure, the PMa SynRM structure of the present invention improves the overall motor performance by achieving increased reluctance-to-permanent magnet torque ratio, decreased torque ripple, reduced dependency on permanent magnets, optimized torque and power characteristics for dominant reluctance torque scenarios by designing for applicable and proper geometric dimensions, material characteristics, winding layouts, and increased energy efficiency and lower environmental impact, as well as being able to withstand higher stresses as a result of increased operating speed.

The radial flux PMa SynRM of the present invention is a three-phase inverter-fed synchronous AC motor which includes a laminated stator core, distributed hairpin windings, and a laminated skewed rotor core having permanent magnets. The radial flux PMa SynRM of the present invention includes a rotor which incorporates at least two U-V flux barriers in the core of the rotor. In an embodiment, the radial flux PMa SynRM of the present invention may have at least two major flux barriers which include magnets and have thicknesses based on the application and required power rating. At least one minor barrier may be in the form of notches to further improve the flux harmonics near the airgap. The notches may be in the form of a barrier, triangle, etc, and does not include a permanent magnet. In an embodiment, the notches may be smaller than the flux barriers, and are closest to the airgap near the rotor outer diameter. The positions of the major (or larger) barriers are closer to the internal shaft, whereas the outer minor (or smaller) barriers are closer to the airgap between the rotor and the stator. In an embodiment, the rotor includes three major barriers distributed in the rotor core, where the first barrier features larger tails compared to the second barrier (the middle barrier), while the third barrier is generally V-shaped, and has no tail. The radial flux PMa SynRM of the present invention creates a gradient (i.e., change in shape, thickness, and angles) from large tails to small tails, enhancing flux asymmetry and consequently increasing reluctance torque, thus improving the overall torque ratio.

The dimensions of the barriers' tails and wings have an influence on magnetic flux distribution. By adjusting both the length and width of the barriers' tails and wings, the contributions of reluctance and permanent magnet torques is directly impacted. For instance, longer barriers on the wings side are designed for all three barriers with a

$$\frac{360}{slot / pole} \pm 5 ° - degree$$

deviation from the center point (i.e., the center point being a line passing through the barriers). Moreover, the length-to-thickness ratio of the flux barriers significantly affects the reluctance and PM torque components. Finding an optimal ratio allows for maximizing the reluctance torque while minimizing demagnetization risks. Balancing the ratio of flux carriers to flux barriers facilitates fine-tuning of the magnetic field distribution as well as ensuring effective utilization of both reluctance and PM torques. Additionally, increasing the number of barriers up to a desired number prior to reaching manufacturability limits and practicality issues creates more salient regions in the motor, thereby boosting reluctance torque. In an embodiment, the radial flux PMa SynRM of the present invention may have at least two major barriers with the aforementioned pattern, where the desired number of flux barriers is selected based on the required power rating.

In an embodiment, the radial flux PMa SynRM of the present invention includes at least two major U-V barriers, along with at least one minor barrier that remains unoccupied by any PMs. Each barrier is characterized by specific ratios and dimensions tailored to optimize motor performance.

In an embodiment, the radial flux PMa SynRM of the present invention is a three-barrier design, where the first barrier features a wing-to-tail length ratio of 3.5-7.5, with a wing length-to-thickness ratio of barriers at 4.5-8, and tail length-to-thickness ratio of barriers at 0.8-2.2. The second barrier features a wing-to-tail length ratio of 6-8, with a wing length-to-thickness ratio of barriers at 4.5-7, and tail length-to-thickness ratio of barriers at 0.65-1.3. The third barrier features a wing-to-tail length ratio of 4.5-11, with wing length-to-thickness ratio of barriers at 2.7-5.5, and tail length-to-thickness ratio of barriers at 0.35-0.85.

In terms of PM distribution, all three major barriers are filled with the same grade of ferrite PMs, where the PMs only occupy the wings, and not the tails. The tails do not have any PMs, preventing demagnetization and reducing centrifugal forces. Radial centrifugal forces are more significant if the inner PMs (i.e., the PMs located at the barrier tails closest to the rotor d-axis) are located at the tails since the entire PM mass is subjected to a radial force. This is not the case for the wing locations as the outer PMs are at an angle and the radial centrifugal forces are less impactful. The wing angle for the outer PMs essentially helps to reduce the need for high mechanical constraints. Controlling the percentage of PM filling in the barriers facilitates maintaining the strength of the magnetic field, especially during continuous and peak operating conditions.

In an embodiment, the barriers include a ratio which is the amount of the barrier occupied by the PM. The barriers may also include a ratio of the lengths of the permanent magnets relative to the lengths of the barriers, which is the PM-to-barrier wing length ratio. In an embodiment, the first barrier includes a PM-to-barrier wing length ratio of 0.82-0.97; the second barrier includes a PM-to-barrier wing length ratio is 0.76-0.91, and the third barrier includes PM-to-barrier wing length ratio is 0.72-0.88.

By carefully managing these variables, a more optimal performance and efficiency of the PMa SynRM drive may be achieved.

The radial flux PMa SynRM of the present invention results in improved thermal, electromagnetic, and structural performance of the electric motor, lower cost design of PMa SynRMs by leveraging higher reluctance torque, and lower risk of PM demagnetization at critical temperature limits.

In an alternate embodiment, a fourth barrier may be added to the rotor to refine the flux path, decrease rotor weight, and improve dynamic of the rotor. The fourth barrier also facilitates protecting the PMs in the first barrier, second barrier, and third barrier against demagnetization. Also, the shapes of the barriers may be changed by increasing the tail dimensions. Furthermore, PMs may be added to the tail section of the barriers, barring any mechanical or demagnetization issues.

In an embodiment, the present invention is a permanent magnet-assisted synchronous reluctance motor (PMa SynRM) structure of an electric motor, which includes a rotor having a plurality of poles. Each of the poles includes a plurality of barriers integrally formed as part of the rotor, and a plurality of permanent magnets, each of the permanent magnets disposed in a corresponding one of the barriers, such that the barriers and the permanent magnets provide desired magnetic flux distribution of the electric motor.

In an embodiment, the barriers include a plurality of pockets, each of the pockets include at least one wing portion, one of the permanent magnets is disposed in the wing portion, and at least one tail portion adjacent the wing portion. The wing portion is longer than the tail portion and the permanent magnet.

In an embodiment, the wing portion includes a first wall portion having a first length, a second wall portion having a second length, the second length being longer than the first length, and a curved outer wall which is adjacent to and integrally formed with the first wall portion and the second wall portion. The permanent magnet is in contact with the first wall portion and the second wall portion.

In an embodiment, the tail portion includes a first side wall having a first length, a second side wall having a second length, where the second length is longer than the first length, and an inner end wall which is adjacent the first side wall and the second side wall. The first side wall is adjacent the first wall portion, and the second side wall is adjacent the second wall portion.

In an embodiment, the first wall portion and the second wall portion are generally parallel to each other, and the first side wall and the second side wall are generally parallel to each other.

In an embodiment, each of the pockets include a wing-to-tail length ratio, the wing-to-tail length ratio being the length of the wing portion divided by the length of the tail portion.

In an embodiment, each of the pockets includes a first plurality of pockets, a second plurality of pockets, and a third plurality of pockets. The second plurality of pockets is disposed between the first plurality of pockets and the third plurality of pockets. In an embodiment, the wing-to-tail length ratio of the wing portion of the first plurality of pockets is greater than the wing-to-tail length ratio of the wing portion of the second plurality of pockets and greater than the wing-to-tail length ratio of the wing portion of the third plurality of pockets.

In an embodiment, the first plurality of pockets include a wing length-to-thickness ratio, the wing length-to-thickness ratio being the length of the wing portion divided by the distance between the wall portions.

In an embodiment, the wing length-to-thickness ratio of the wing portion of the third plurality of pockets is less than the wing length-to-thickness ratio of the wing portion of the second plurality of pockets, and the wing length-to-thickness ratio of the wing portion of the second plurality of pockets is less than the wing length-to-thickness ratio of the wing portion of the first plurality of pockets.

In an embodiment, the pockets include a tail length to-thickness ratio, the tail length to-thickness ratio being the length of the tail portion divided by the distance between the side walls.

In an embodiment, each of the pockets includes a first plurality of pockets, a second plurality of pockets, and a third plurality of pockets. The second plurality of pockets is disposed between the first plurality of pockets and the third plurality of pockets. In an embodiment, the tail length to-thickness ratio of the wing portion of the third plurality of pockets is less than the tail length to-thickness ratio of the wing portion of the first plurality of pockets and less than the tail length to-thickness of the wing portion of the second plurality of pockets.

In an embodiment, each of the plurality of pockets include a permanent magnet (PM)-to-barrier wing length ratio, which is the length of one of the permanent magnets divided by the length of the at least one wing portion.

In an embodiment, each of the plurality of pockets includes a first plurality of pockets, a second plurality of pockets, and a third plurality of pockets, where the second plurality of pockets is disposed between the first plurality of pockets and the third plurality of pockets. In an embodiment, the PM-to-barrier wing length ratio of each of the first of the plurality of pockets is greater than the PM-to-barrier wing length ratio of each of the second plurality of pockets and/or the PM-to-barrier wing length ratio of each of the third plurality of pockets.

In an embodiment, each of a plurality of radial ribs are located between the tail portion of two of the plurality of pockets, and each of the plurality of radial ribs includes a radial rib width-to-height ratio, which is the width of each of the plurality of radial ribs divided by the corresponding height.

In an embodiment, each of the plurality of pockets includes a first plurality of pockets, a second plurality of pockets, and a third plurality of pockets, where the second plurality of pockets is disposed between the first plurality of pockets and the third plurality of pockets. In an embodiment, the radial rib width-to-height ratio of the one of the radial ribs between the tail portions of the first plurality of pockets is greater than the radial rib width-to-height ratio of one of the radial ribs between the tail portions of the second plurality of pockets, and the radial rib width-to-height ratio of the one of the radial ribs between the tail portions of the second plurality of pockets is greater than the radial rib width-to-height ratio of one of the radial ribs between the tail portions of the third plurality of pockets.

In an embodiment, each of a plurality of tangential ribs being located between the wing portion and the outer diameter of the rotor, and each of the plurality of tangential ribs includes a tangential rib width-to-height ratio, which is the width of each of the plurality of tangential ribs divided by the corresponding height.

In an embodiment, each of the plurality of pockets includes a first plurality of pockets, a second plurality of pockets, and a third plurality of pockets, where the second plurality of pockets is disposed between the first plurality of pockets and the third plurality of pockets. In an embodiment, the tangential rib width-to-height ratio of the one of the tangential ribs adjacent one of the first plurality of pockets is greater than tangential rib width-to-height ratio of the one of the tangential ribs adjacent one of the second plurality of pockets, and the tangential rib width-to-height ratio of the one of the tangential ribs adjacent the one of the second plurality of pockets is greater than tangential rib width-to-height ratio of one of the tangential ribs adjacent one of the third plurality of pockets.

In an embodiment, a permanent magnet (PM) offset ratio is the ratio of the radius of the outer edge of each of the permanent magnets relative to the radius of the outer surface of the rotor. In an embodiment, each of the plurality of pockets includes a first plurality of pockets, a second plurality of pockets, and a third plurality of pockets, where the second plurality of pockets is disposed between the first plurality of pockets and the third plurality of pockets. In an embodiment, the PM offset ratio of a first of the magnets located in a first of the first plurality of pockets is less than the PM offset ratio of a second of the magnets located in a first of the second plurality of pockets, and the PM offset ratio of the second of the magnets located in the first of the second plurality of pockets is less than the PM offset ratio of a third of the magnets located in one of the third plurality of pockets.

In an embodiment, a barrier outer offset ratio is the ratio of the radius of the outer edge of each of the plurality of pockets relative to the radius of the outer surface of the rotor. In an embodiment, each of the plurality of pockets includes a first plurality of pockets, a second plurality of pockets, and a third plurality of pockets, where the second plurality of pockets is disposed between the first plurality of pockets and the third plurality of pockets. In an embodiment, the barrier outer offset ratio of each of the first plurality of pockets is less than the barrier outer offset ratio of each of the second plurality of pockets, and the barrier outer offset ratio of each of the second plurality of pockets is less than the barrier outer offset ratio of each of the third plurality of pockets.

In an embodiment, a barrier inner offset ratio is the ratio of the radius of the inner edge of each of the plurality of pockets relative to the radius of the outer surface of the rotor. In an embodiment, each of the plurality of pockets includes a first plurality of pockets, a second plurality of pockets, and a third plurality of pockets, where the second plurality of pockets is disposed between the first plurality of pockets and the third plurality of pockets. In an embodiment, the barrier inner offset ratio of each of the first plurality of pockets is less than the barrier inner offset ratio of each of the second plurality of pockets and, the barrier inner offset ratio of each of the second plurality of pockets is less than the barrier inner offset ratio of the third plurality of pockets.

In an embodiment, each of the plurality of pockets includes a recess formed as part of the tail portion, the recess being a flux leakage blocker, and at least one fillet integrally formed as part of the recess, the fillet distributing local stresses and preventing rotational magnetic fluxes. The recess of a first of the pockets has a height that is less than the recess of a second of the pockets, and the recess of a second of the pockets has a height that is less than the recess of a third of the pockets. In an embodiment, the recess of the first of the pockets has a width that is wider than the recess of the second of the pockets, and the recess of the second of the pockets has a width that is wider than the recess of the third of the pockets.

In an embodiment, each of the plurality of pockets includes a plurality of barrier fillets integrally formed as part of the wing portion, and a plurality of barrier fillets integrally formed as part of the tail portion. In an embodiment, the plurality of barrier fillets integrally formed as part of the wing portion and the plurality of barrier fillets integrally formed as part of the tail portion are shaped to withstand the structural stresses resulting from centrifugal forces due to elevated rotational speeds of the rotor and facilitate a smooth magnetic circuit for linking the magnetic flux from the rotor to the stator. In an embodiment, the radii of each of the plurality of barrier fillets integrally formed as part of the tail portion of each of the plurality of pockets closer to the inner diameter of the rotor is significantly higher than the radii of each of the plurality of barrier fillets integrally formed as part of the tail portion of each of the plurality of pockets closest to the outer diameter of the rotor.

In an embodiment, each of the plurality of pockets includes a plurality of protrusions integrally formed as part of the rotor, and each of the plurality of permanent magnets is held in position by two of the plurality of protrusions.

In an embodiment, an outer pocket functions as a minor flux barrier, and the outer pocket is located closer to the outer diameter of the rotor compared to the each of plurality of pockets.

In an embodiment, each of the plurality of permanent magnets includes a plurality of magnets fillets, such that each of the plurality of magnet fillets is integrally formed as part of a corresponding one of the plurality of permanent magnets. The plurality of magnet fillets distribute the magnetic field intensity near the corners of each of the plurality of permanent magnets.

In an embodiment, each of the permanent magnets are located at an angle relative to one another.

In an embodiment, a PM-to-barrier fill ratio is the portion of each of the plurality of pockets occupied by a corresponding one of the plurality of permanent magnets. In an embodiment, each of the plurality of pockets includes a first plurality of pockets, a second plurality of pockets, and a third plurality of pockets, where the second plurality of pockets is disposed between the first plurality of pockets and the third plurality of pockets. In an embodiment, the PM-to-barrier fill ratio of each of the first plurality of pockets is greater than the PM-to-barrier fill ratio of each of the second plurality of pockets, and the PM-to-barrier fill ratio of each of the second plurality of pockets is greater than the PM-to-barrier fill ratio of the third plurality of pockets.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a side view of a stator and a rotor having a permanent magnet-assisted synchronous reluctance motor (PMa SynRM) structure, according to embodiments of the present invention;

FIG. 2 is an enlarged view of a portion of FIG. 1, with the permanent magnets disposed in the barriers;

FIG. 3 is an enlarged side view of a portion of rotor with the permanent magnets removed, where the rotor is part of a PMa SynRM structure, according to embodiments of the present invention;

FIG. 4A is an enlarged view of one of a first plurality of cavities of a rotor having a PMa SynRM structure, according to embodiments of the present invention;

FIG. 4B is an enlarged view of one of a second plurality of cavities of a rotor having a PMa SynRM structure, according to embodiments of the present invention;

FIG. 4C is an enlarged view of one of a third plurality of cavities of a rotor having a PMa SynRM structure, according to embodiments of the present invention;

FIG. 5 is a top view of a plurality of permanent magnets used as part of a rotor having a PMa SynRM structure, according to embodiments of the present invention;

FIG. 6 is an enlarged side view of a portion of rotor, where the rotor is part of a PMa SynRM structure, according to embodiments of the present invention;

FIG. 7 is a side view of an alternate embodiment of rotor, where the rotor is part of a PMa SynRM structure, according to embodiments of the present invention;

FIG. 8 is a perspective view of an alternate embodiment of rotor, where the rotor is part of a PMa SynRM structure, according to embodiments of the present invention;

FIG. 9 is an enlarged view of a portion of the rotor shown in FIG. 7;

FIG. 10A is an enlarged view of a portion of the rotor shown in FIG. 9;

FIG. 10B is an enlarged view of a portion of FIG. 10A;

FIG. 11A is an enlarged view of another portion of the rotor shown in FIG. 9;

FIG. 11B is an enlarged view of a portion of FIG. 11A;

FIG. 12A is an enlarged view of another portion of the rotor shown in FIG. 9;

FIG. 12B is an enlarged view of a portion of FIG. 12A;

FIG. 13 is an enlarged view of a portion of the rotor shown in FIG. 7; and

FIG. 14 is another enlarged view of a portion of the rotor shown in FIG. 7.

### DETAILED DESCRIPTION OF THE PREFERRED EMBODIMENTS

The following description of the preferred embodiment(s) is merely exemplary in nature and is in no way intended to limit the invention, its application, or uses.

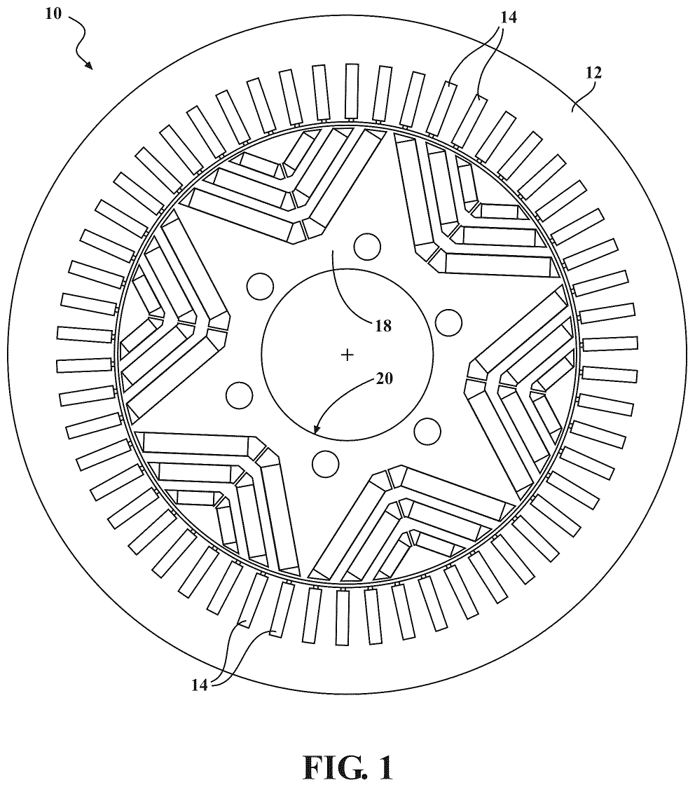

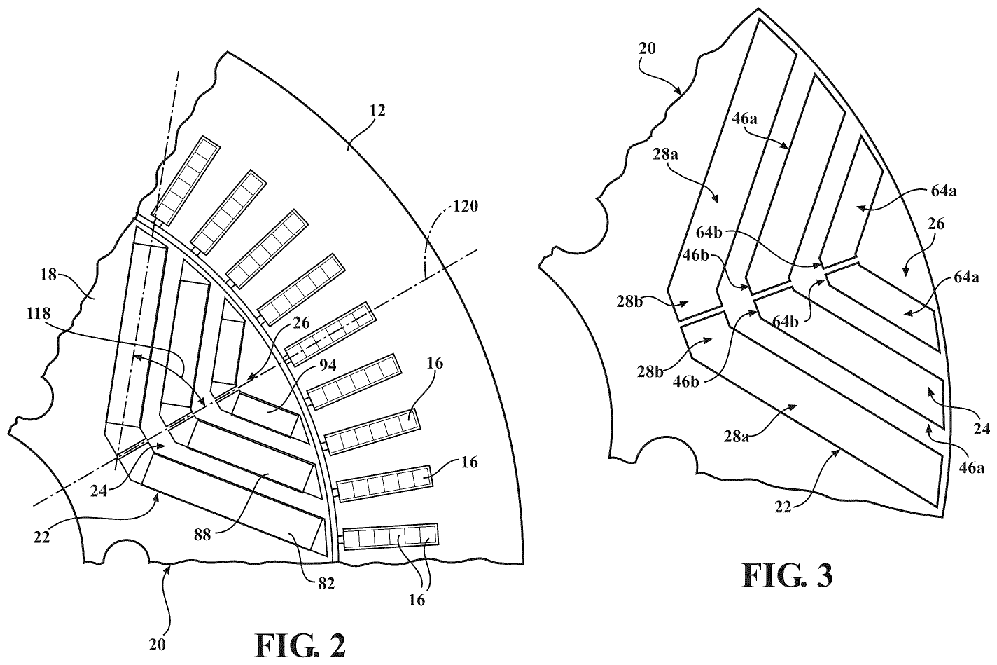

An embodiment of an electric motor having a permanent magnet-assisted synchronous reluctance motor (PMa SynRM) structure according to the present invention is shown in FIG. 1, generally at 10. More specifically, the electric motor shown in FIG. 1 includes a stator 12 having a plurality of slots 14, and extending through the slots 14 is a plurality of coil windings 16 (shown in FIG. 2). In the embodiment shown, there are fifty-four slots 14, but it is within the scope of the invention that more or less slots 14 may be used.

Referring to FIGS. 1-2, surrounded by the stator 12 is a rotor 18, where the rotor 18 is formed by assembling a plurality of laminations, shown generally at 20. When the laminations 20 are assembled, several pockets are formed. More specifically, there is a first plurality of pockets, shown generally at 22, a second plurality of pockets, shown generally at 24, and a third plurality of pockets, shown generally at 26. Each of the pluralities of pockets 22,24,26 function as a flux barrier, to maximize average torque and minimize torque ripple of the electric motor 10.

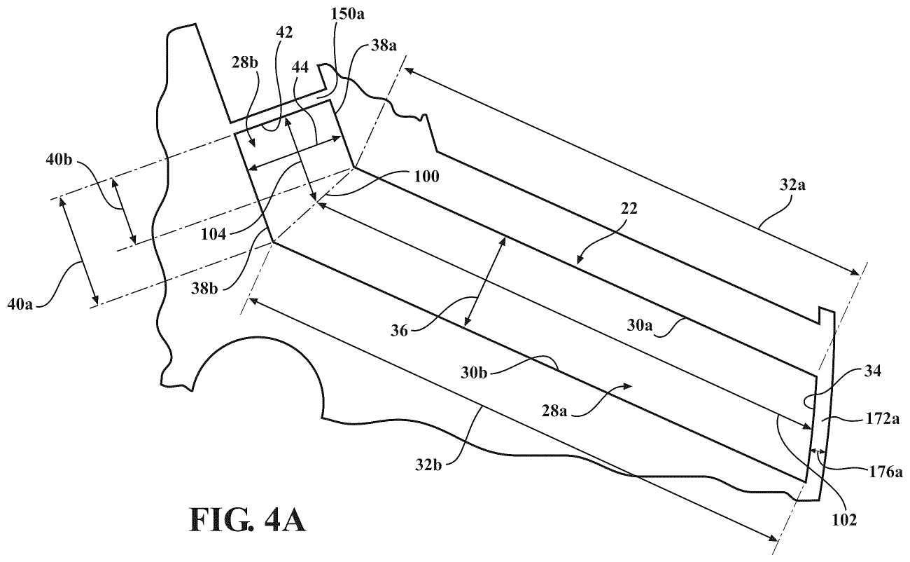

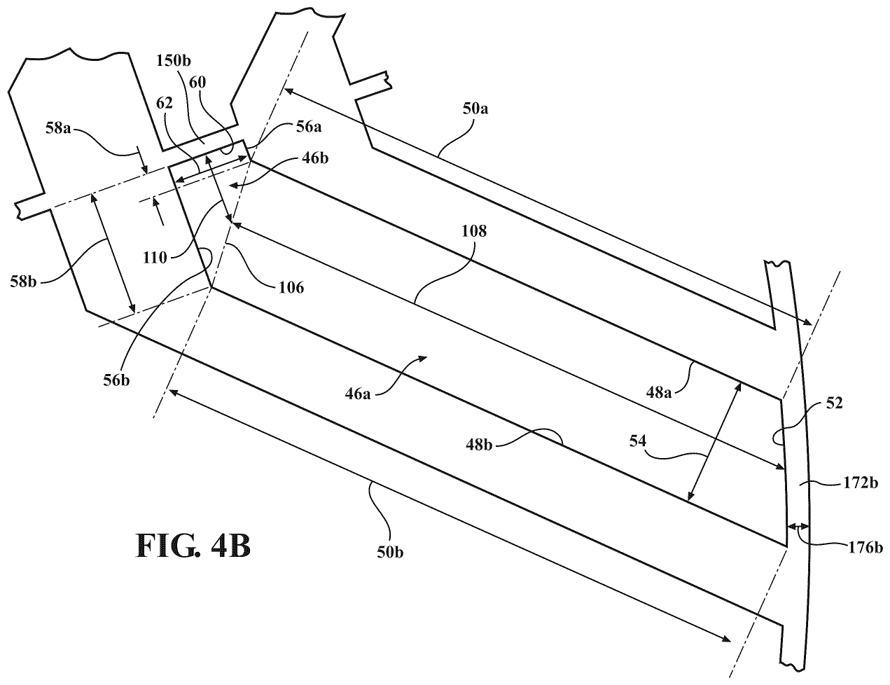

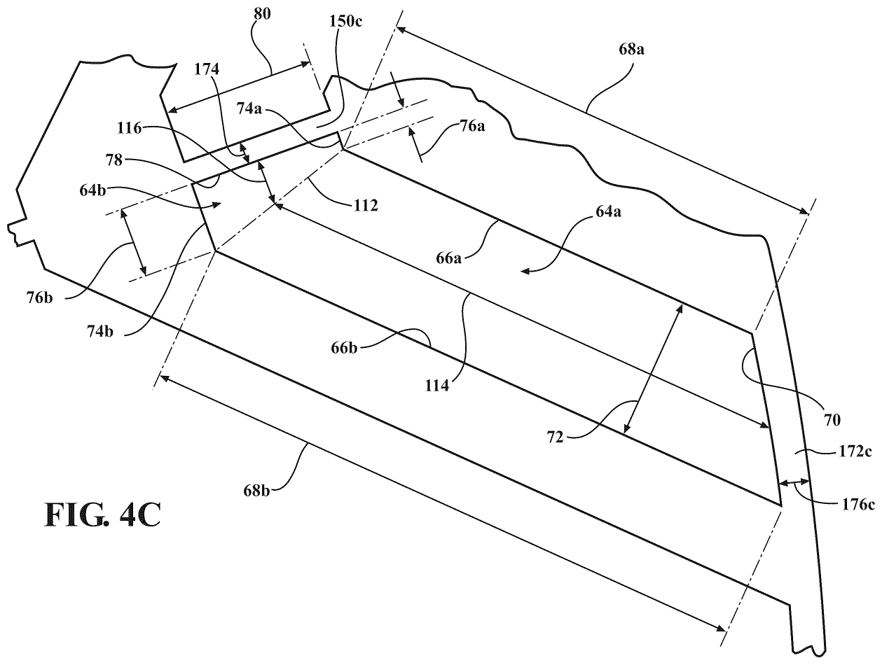

Referring to FIGS. 3, and 4A each of the first plurality of pockets 22 includes a wing portion, shown generally at 28a, and a tail portion, shown generally at 28b. The wing portion 28a has a first wall portion 30a having a first length 32a, and a second wall portion 30b having a second length 32b, where the second length 32b is longer than the first length 32a. The wing portion 28a also includes a curved outer wall 34 which is adjacent the first wall portion 30a and the second wall portion 30b. The first wall portion 30a and the second wall portion 30b are generally parallel to each other and are located at a distance 36 from one another.

The tail portion 28b includes a first side wall 38a having a first length 40a, and a second side wall 38b having a second length 40b, where the second length 40b is longer than the first length 40a. The first side wall 38a of the tail portion 28b is adjacent the first wall portion 30a of the wing portion 28a, and the second side wall 38b of the tail portion 28b is adjacent the second wall portion 30b of the wing portion 28a. The tail portion 28b also includes an inner end wall 42, which is adjacent the first side wall 38a and the second side wall 38b. The first side wall 38a and the second side wall 38b are generally parallel to each other and are located at a distance 44 from one another. Although the wall portions 30a,30b are shown as being in parallel to one another, and the side walls 38a,38b are shown as being in parallel to one another, it is within the scope of the invention that in an alternate embodiment the wall portions 30a,30b may be positioned at an angle relative to one another, and the side walls 38a,38b may be positioned at an angle relative to one another, depending upon the desired design and performance of the electric motor 10.

Referring to FIGS. 3 and 4B, each of the second plurality of pockets 24 includes a wing portion, shown generally at 46a, and a tail portion, shown generally at 46b. The wing portion 46a has a first wall portion 48a having a first length 50a, and a second wall portion 48b having a second length 50b, where the second length 50b is longer than the first length 50a. The wing portion 46a also includes a curved outer wall 52 which is adjacent the first wall portion 48a and the second wall portion 48b. The first wall portion 48a and the second wall portion 48b are generally parallel to each other, and are located at a distance 54 from one another.

The tail portion 46b includes a first side wall 56a having a first length 58a, and a second side wall 56b having a second length 58b, where the second length 58b is longer than the first length 58a. The first side wall 56a of the tail portion 46b is adjacent the first wall portion 48a of the wing portion 46a, and the second side wall 56b of the tail portion 46b is adjacent the second wall portion 48b of the wing portion 46a. The tail portion 46b also includes an inner end wall 60, which is adjacent the first side wall 56a and the second side wall 56b. The first side wall 56a and the second side wall 56b are generally parallel to each other and are located at a distance 62 from one another. Although the wall portions 48a,48b are shown as being in parallel to one another, and the side walls 56a,56b are shown as being in parallel to one another, it is within the scope of the invention that in an alternate embodiment the wall portions 48a,48b may be positioned at an angle relative to one another, and the side walls 56a,56b may be positioned at an angle relative to one another, depending upon the desired design and performance of the electric motor 10.

Referring to FIGS. 3 and 4C, each of the third plurality of pockets 26 includes a wing portion, shown generally at 64a, and a tail portion, shown generally at 64b. The wing portion 64a has a first wall portion 66a having a first length 68a, and a second wall portion 66b having a second length 68b, where the second length 68b is longer than the first length 68a. The wing portion 64a also includes a curved outer wall 70 which is adjacent the first wall portion 66a and the second wall portion 66b. The first wall portion 66a and the second wall portion 66b are generally parallel to each other and are located at a distance 72 from one another.

The tail portion 64b includes a first side wall 74a having a first length 76a, and a second side wall 74b having a second length 76b, where the second length 76b is longer than the first length 76a. The first side wall 74a of the tail portion 64b is adjacent the first wall portion 66a of the wing portion 64a, and the second side wall 74b of the tail portion 64b is adjacent the second wall portion 66b of the wing portion 64a. The tail portion 64b also includes an inner end wall 78, which is adjacent the first side wall 74a and the second side wall 74b. The first side wall 74a and the second side wall 74b are generally parallel to each other and are located at a distance 80 from one another. Although the wall portions 66a,66b are shown as being in parallel to one another, and the side walls 74a,74b are shown as being in parallel to one another, it is within the scope of the invention that in an alternate embodiment the wall portions 66a,66b may be positioned at an angle relative to one another, and the side walls 74a,74b may be positioned at an angle relative to one another, depending upon the desired design and performance of the electric motor 10.

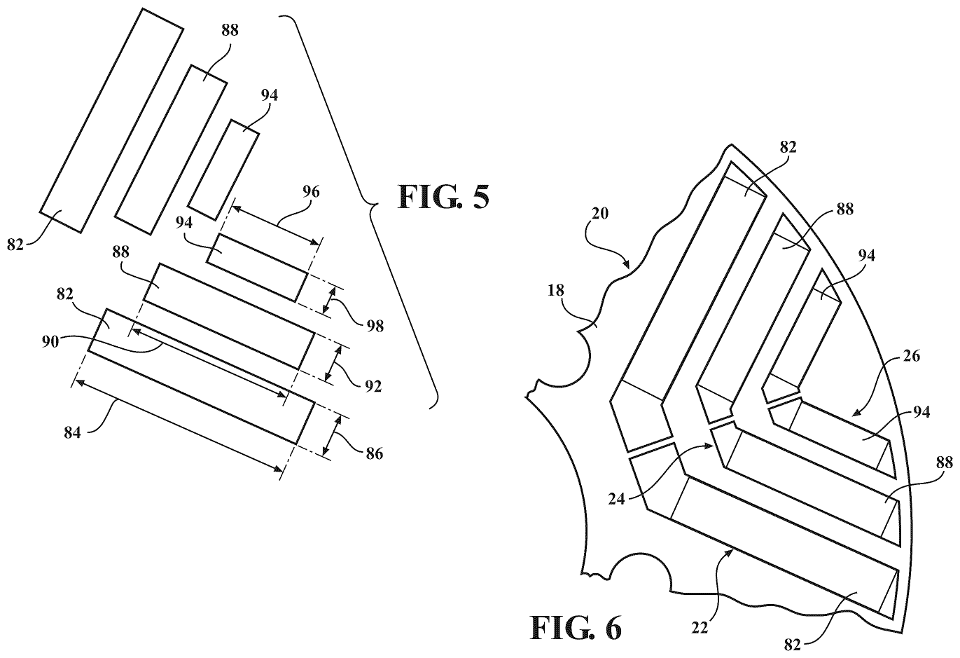

Referring to FIG. 5, several of the permanent magnets are shown. More specifically, a first permanent magnet 82 is shown, which is located in one of the wing portions 28a of the first plurality of pockets 22. The permanent magnet 82 has a length 84 which corresponds to the length 32a of the first wall portion 30a, and a width 86 which corresponds to the distance 36 between the wall portions 30a,30b, such that the permanent magnet 82 is disposed in the wing portion 28a of one of the first plurality of pockets 22 using an interference fit.

A second permanent magnet 88 is shown, which is located in one of the wing portions 46a of the second plurality of pockets 24. The permanent magnet 88 has a length 90 which corresponds to the length 50a of the first wall portion 48a, and a width 92 which corresponds to the distance 54 between the wall portions 48a,48b, such that the permanent magnet 88 is disposed in the wing portion 46a of one of the second plurality of pockets 24 using an interference fit.

A third permanent magnet 94 is shown, which is located in one of the wing portions 64a of the third plurality of pockets 26. The permanent magnet 94 has a length 96 which corresponds to the length 68a of the first wall portion 66a, and a width 98 which corresponds to the distance 72 between the wall portions 66a,66b, such that the permanent magnet 88 is disposed in the wing portion 64a of one of the third plurality of pockets 26 using an interference fit.

The wing portions 28a of the first plurality of pockets 22 are parallel to the corresponding wing portions 46a of the second plurality of pockets 24, and the wing portions 64a of the third plurality of pockets 26 are all parallel to the corresponding wing portions 46a of the second plurality of pockets 24, such that the corresponding wing portions 28a,46a,64a are all parallel to one another. Therefore, when the permanent magnets 82,88,94 are disposed in the corresponding wing portions 28a,46a,64a, the groups of permanent magnets 82,88,94 are also parallel to one another. However, it is within the scope of the invention that wing portions 28a of the first plurality of pockets 22, the wing portions 46a of the second plurality of pockets 24, and the wing portions 64a of the third plurality of pockets 26, may be positioned at various angles relative to one another, such that the permanent magnets 82,88,94 are not parallel to each other, depending upon the desired design and performance of the electric motor 10.

Similarly, the tail portions 28b of each of the first plurality of pockets 22 are parallel to the tail portions 46b of the second plurality of pockets 24, and the tail portions 64b of the third plurality of pockets 26 are all parallel to tail portions 46b of the second plurality of pockets 24, such that the tail portions 28b,64b,64b are all parallel to one another.

Each tail portion 28b of the first plurality of pockets 22 is located at an angle relative to a corresponding wing portion 28a of the first plurality of pockets 22. Each tail portion 46b of the second plurality of pockets 24 is located at the same angle relative to a corresponding wing portions 46a of the second plurality of pockets 24. Each tail portion 64b of the third plurality of pockets 26 are also located at the same angle relative to a corresponding wing portions 64a of the third plurality of pockets 26.

None of the tail portions 28b,46b,64b are occupied by any portion of the permanent magnets 82,88,94. The tail portions 28b,46b,64b being unoccupied by the permanent magnets 82,88,94 prevents demagnetization and reduces centrifugal forces on the electric motor 10.

The electric motor 10 having a PMa SynRM structure according to the present invention has three pluralities of pockets 22,24,26, which function as barriers as described above. The sizes of the wing portions 28a,46a,64a relative to the tail portions 28b,46b,64b may be characterized by ratios and dimensions to facilitate optimal performance of the electric motor 10.

With reference to the first plurality of pockets 22, an end of the wing portions 28a is shown by a dashed line 100, which also represents an end of the tail portions 28b. The length 102 of the wing portions 28a is defined as the distance between the curved outer wall 34 and the dashed line 100, where the length 102 is measured half-way between the wall portions 30a,30b, as shown in FIG. 4A. The thickness of the wing portions 28a corresponds to the distance 36 between the wall portions 30a30b.

The length 104 of the tail portions 28b is defined as the distance between the inner end wall 42 and dashed line 100, where the length 104 is measured half-way between the side walls 38a,38b, also shown in FIG. 4A. The thickness of the tail portions 28b corresponds to the distance 44 between the side walls 38a,38b.

Each of the first plurality of pockets 22 has a wing-to-tail length ratio, where the ratio of the length 102 of the wing portion 28a to the length 104 of the tail portion 28b is between 3.5-7.5.

Each of the wing portions 28a of the first plurality of pockets 22 also includes a wing length-to-thickness ratio, where the length 102 of the wing portions 28a to the distance 36 between the wall portions 30a30b of the wing portions 28a is between 4.5-8.

Each of the tail portions 28b of the first plurality of pockets 22 also has a tail length-to-thickness ratio, where the length 104 of the tail portions 28b to the distance 44 between the side walls 38a,38b is between 0.8-2.2.

With reference to the second plurality of pockets 24, an end of the wing portions 46a is shown by a dashed line 106, which also represents an end of the tail portions 46b. The length 108 of the wing portions 46a is defined as the distance between the curved outer wall 52 and the dashed line 106, where the length 108 is measured half-way between the wall portions 48a,48b, as shown in FIG. 4B. The thickness of the wing portions 46a corresponds to the distance 54 between the wall portions 48a,48b.

The length 110 of the tail portions 46b is defined as the distance between the inner end wall 60 and dashed line 106, where the length 110 is measured half-way between the side walls 56a,56b, also shown in FIG. 4B. The thickness of the tail portions 46b corresponds to the distance 62 between the side walls 56a,56b.

Each of the second plurality of pockets 24 has a wing-to-tail length ratio, where the ratio of the length 108 of the wing portion 46a to the length 110 of the tail portion 46b is between 6-8.

Each of the wing portions 46a of the second plurality of pockets 24 also includes a wing length-to-thickness ratio, where the length 108 of the wing portions 46a to the distance 54 between the wall portions 48a48b of the wing portions 46a is between 4.5-7.

Each of the tail portions 46b of the second plurality of pockets 24 also has a tail length-to-thickness ratio, where the length 110 of the tail portions 46b to the distance 62 between the side walls 56a,56b is between 0.65-1.3.

With reference to the third plurality of pockets 26, an end of the wing portions 64a is shown by a dashed line 112, which also represents an end of the tail portions 64b. The length 114 of the wing portions 64a is defined as the distance between the curved outer wall 70 and the dashed line 112, where the length 114 is measured half-way between the wall portions 66a,66b, as shown in FIG. 4C. The thickness of the wing portions 64a corresponds to the distance 72 between the wall portions 66a,66b.

The length 116 of the tail portions 64b is defined as the distance between the inner end wall 78 and the dashed line 112, where the length 116 is measured half-way between the side walls 74a,74b, also shown in FIG. 4C. The thickness of the tail portions 64b corresponds to the distance 80 between the side walls 74a,74b.

Each of the third plurality of pockets 26 has a wing-to-tail length ratio, where the ratio of the length 114 of the wing portion 64a to the length 116 of the tail portion 64b is between 4.5-11.

Each of the wing portions 64a of the third plurality of pockets 26 also includes a wing length-to-thickness ratio, where the length 114 of the wing portions 64a to the distance 72 between the wall portions 66a,66b of the wing portions 64a is between 2.7-5.5.

Each of the tail portions 64b of the third plurality of pockets 26 also has a tail length-to-thickness ratio, where the length 116 of the tail portions 64b to the distance 80 between the side walls 74a,74b is between 0.35-0.85.

In an embodiment, the area of each of the wing portions 28a,46a,64a occupied by the permanent magnets 82,88,94 may also be defined as a PM-to-barrier wing length ratio of length of each wing portion 28a,46a,64a relative to the length of each permanent magnets 82,88,94 (i.e., the length of the permanent magnets 82,88,94 divided by the length of the corresponding wing portions 28a,46a,64a).

As mentioned above, the permanent magnets 82,88,94 do not occupy the entire wing portions 28a,46a,64a of the pockets 22,24,26, respectively. Controlling the percentage of the pockets 22,24,26 occupied by the permanent magnets 82,88,94 facilitates maintaining the strength of the magnetic field, especially during continuous and peak operating conditions. The lengths 102,108,114 of the wing portions 28a,46a,64a described above are longer than the lengths 84,90,96 of the permanent magnets 82,88,94.

With regard to the first plurality of pockets 22, the PM-to-barrier wing length ratio of the length 84 of the permanent magnets 82 to the length 102 of the wing portion 28a is between 0.82-0.97.

With regard to the second plurality of pockets 24, the PM-to-barrier wing length ratio of the length 90 of the permanent magnets 88 to the length 108 of the wing portion 46a is between 0.76-0.91.

With regard to the third plurality of pockets 26, the PM-to-barrier wing length ratio of the length 96 of the permanent magnets 94 to the length 114 of the wing portion 64a is between 0.72-0.88.

As mentioned above, each plurality of pockets 22,24,26 includes a tail portion 28b,46b,64b located at an angle relative to the corresponding wing portion 28a,46a,64a. In the embodiment shown, the electric motor 10 includes six poles, where each pole includes the pluralities of pockets 22,24,26 and corresponding permanent magnets 82,88,94. An example of one of the poles is shown in FIG. 2.

As previously mentioned, the pluralities of pockets 22,24,26 are designed such that the wing portions 28a,46a,64a are located at an angle 118 which is

$$\frac{360}{slot / pole} \pm 5 ° - degree$$

deviation from the center point, where the center point is shown as a line 120 passing through the pockets 22,24,26 in FIG. 2.

The rotor 18 also include a plurality of radial ribs 150a, 150b, 150c and tangential ribs 172a, 172b, 172c. Referring to FIGS. 4A, 4B, and 4C, the radial ribs 150a, 150b, 150c are located between the tail portions 286,46b,64b of the pockets 22,24,26. In addition to the radial ribs 150a, 150b, 150c, the rotor 18 also includes the tangential ribs 172a, 172b, 172c, which are the areas of the laminations 20 between the wing portions 28a,46a,64a and the outer diameter of the rotor 18.

The radial ribs 150a, 150b, 150c have a radial rib width-to-height ratio, which is the width 174 of each radial rib 150a, 150b, 150c divided by the corresponding height. The width 174 (an example of which is shown in FIG. 4C) of each radial rib 150a, 150b, 150c is the same (i.e., the distance between the tails portions 28b,46b,64b of the corresponding pockets 22,24,26).

The height of the radial rib 150a between the tail portions 28b of the first plurality of pockets 22 is the same as the distance 44 between the side walls 38a,38b. The radial rib width-to-height ratio of the radial rib 150a between the tail portions 28b of the first plurality of pockets 22 is 0.28-0.36.

The height of the radial rib 150b between the tail portions 46b of the second plurality of pockets 24 is the same as the distance 62 between the side walls 56a,56b. The radial rib width-to-height ratio of the radial rib 150b between the tail portions 46b of the second plurality of pockets 24 is 0.22-0.30.

The height of the radial rib 150c between the tail portions 64b of the third plurality of pockets 26 is the same as the distance 80 between the side walls 74a,74b. The radial rib width-to-height ratio of the radial rib 150c between the tail portions 64b of the third plurality of pockets 26 is 0.18-0.24.

The tangential ribs 172a, 172b, 172c have a tangential rib width-to-height ratio, which is the width 176a, 176b, 176c of each tangential rib 172a, 172b, 172c divided by the corresponding height.

The width 176a,176b,176c of each tangential rib 172a, 172b, 172c is the same (i.e., the distance between the curved outer wall 34,52,70 and the outer surface of the rotor 18).

The height of each tangential rib 172a adjacent the first plurality of pockets 22 corresponds to the length of the curved outer wall 34. The tangential rib width-to-height ratio of the tangential rib 172a adjacent the wing portions 28a of the first plurality of pockets 22 is 0.28-0.40.

The height of each tangential rib 172b adjacent the second plurality of pockets 24 corresponds to the length of the curved outer wall 52. The tangential rib width-to-height ratio of the tangential rib 172b adjacent the wing portions 46a of the second plurality of pockets 24 is 0.18-0.24.

The height of each tangential rib 172c adjacent the third plurality of pockets 26 corresponds to the length of the curved outer wall 70. The tangential rib width-to-height ratio of the tangential rib 172c adjacent the wing portions 64a of the third plurality of pockets 26 is 0.14-0.22.

Although the rotor 18 of the electric motor 10 is shown having the first plurality of pockets 22, the second plurality of pockets 24, and the third plurality of pockets 26, it is within the scope of the invention that the rotor 18 may have any number of pockets from 1 to N pockets.

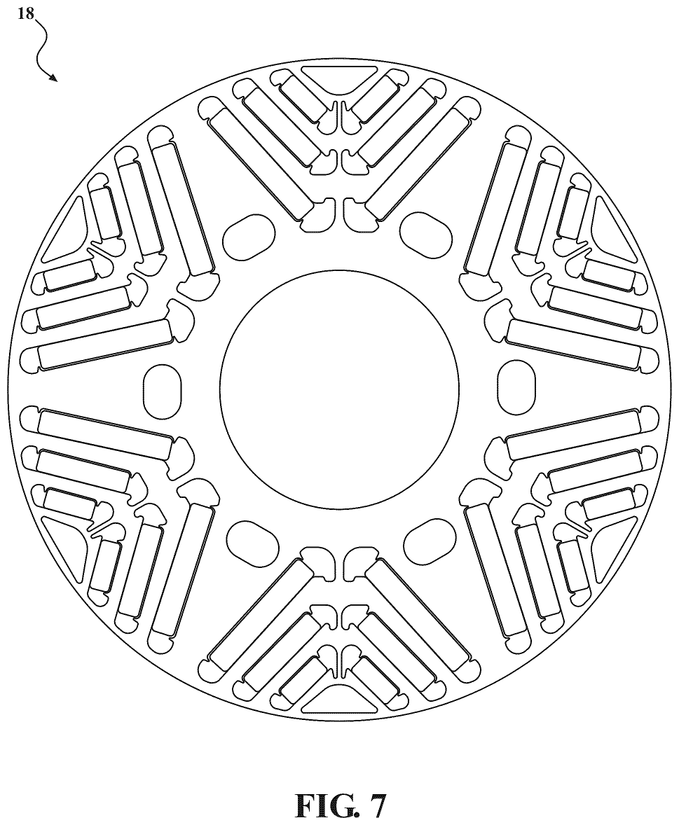

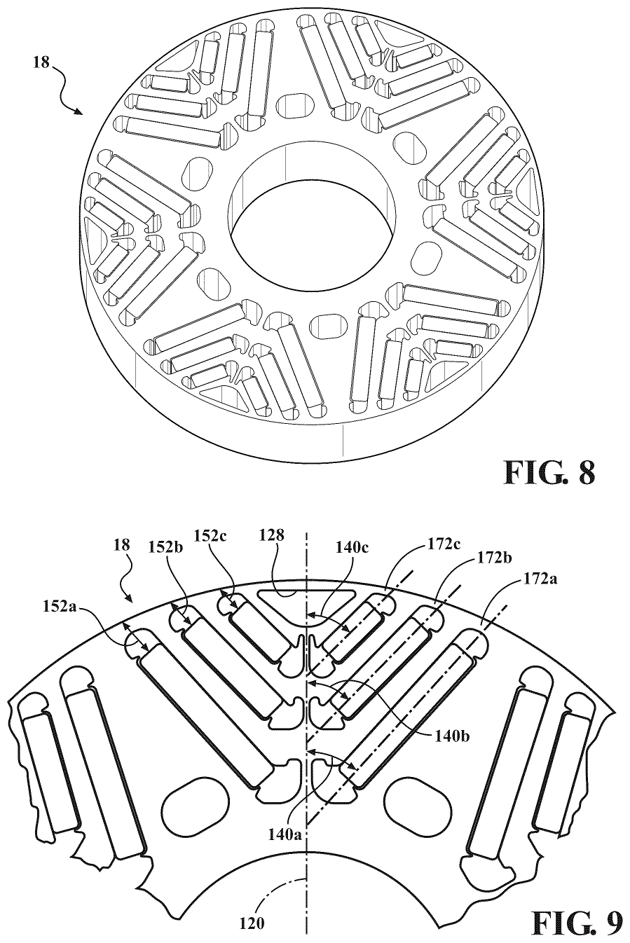

Another embodiment of the present invention is shown in FIGS. 7-14, with like numbers referring to like elements. In this embodiment, the tail portions 286,46b,64b of each of the pockets 22,24,26 includes a corresponding recess 122, 124, 126, each of which functions as a “flux leakage blocker.”

Flux leakage degrades the magnetic loading capability of the motor 10 and consequently reduces the performance characteristics such as torque, power and efficiency for various operating points of the motor 10. During operation of the motor 10, the flux from the permanent magnets 82,88,94 flows along a desired magnetic path to other parts of the motor 10, such as the stator windings across the airgap between the stator 12 and the rotor 18. The recesses 122,124,126 prevent the magnetic flux from leaking from the desired magnetic path and prevent the magnetic flux from each corresponding magnet 82,88,94 from being effectively linked with the windings of the stator 12 and looping around the respective magnet 82,88,94, and linking with itself near the center line of each pole of the rotor 18.

In addition to being shaped to function as flux leakage blockers, the shape of the recesses 122, 124, 126 also facilitates a reduction in local stresses resulting from centrifugal forces at elevated speeds of the rotor 18. Any of the recesses 122,124, 126 being shaped shorter and wider facilitates a reduction in local stresses but is less optimal for achieving desired magnetic performance. Conversely, any of the recesses 122,124,126 being shaped taller and thinner facilitates desired magnetic performance, but also has increased local stresses.

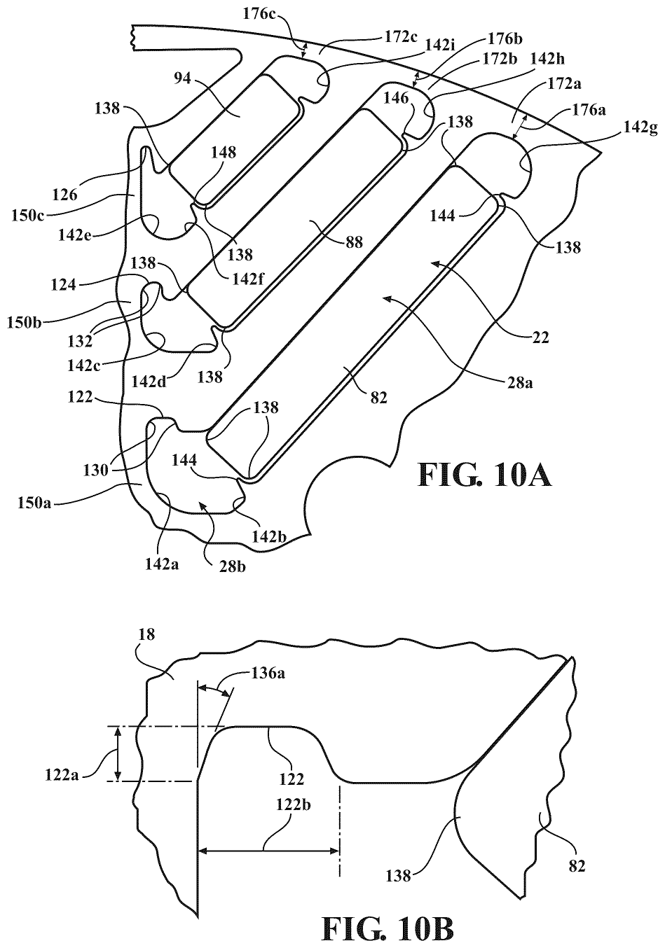

With specific reference to FIGS. 10B, 11B, and 12B, each recess 122,124,126 has a height and a width. More specifically, the recess 122 of the tail portion 28b has a height 122a and a width 122b, the recess 124 of the tail portion 46b has a height 124a and a width 124b, and the recess 126 of the tail portion 64b has a height 126a and a width 126b.

The recess 122 of the tail portion 28b is shaped such that the height 122a is less than the heights 124a, 126a of the recesses 124,126, respectively, and the width 122b is wider than the widths 124b, 126b of the recesses 124,126 because the recess 122 is closest to the inner diameter of the rotor 18 and is therefore exposed to the highest local stresses resulting from centrifugal forces at elevated speeds of the rotor 18.

Again, with specific reference to FIGS. 10B, 11B, and 12B, the height 122a of the recess 122 of the innermost tail portion 28b is less than the height 124a of the recesses 124 of the middle tail portion 46b, and the height 124a of the recesses 124 of the middle tail portion 46b is less than the height 126b of the recess 126 of the outermost tail portion 64b. Additionally, the width 122b of the recess 122 of the innermost tail portion 28b is wider than the width 124b of the recesses 124 of the middle tail portion 46b, and the width 124b of the recesses 124 of the middle tail portion 46b is wider than the width 124b of the recess 126 of the outermost tail portion 64b. The recesses 122,124, 126 are progressively taller and thinner (facilitating desired electromagnetic performance) the further away the recesses 122,124,126 are located from the inner diameter of the rotor 18. The further away the recesses 122, 124, 126 are located from the inner diameter of the rotor 18, the less the amount of lamination mass that is necessary to be distributed as a result of the shape of the recesses 122,124, 126.

Also, all the recesses 122,124,126 have curved surfaces, or recess “fillets” 130,132,134 to distribute local stresses and prevent rotational magnetic fluxes, where the magnetic flux rotates in a local area instead of passing from the rotor 18 to the stator 12, causing an increase in the iron losses of the rotor 18 and unwanted local magnetic saturation of the laminations 20.

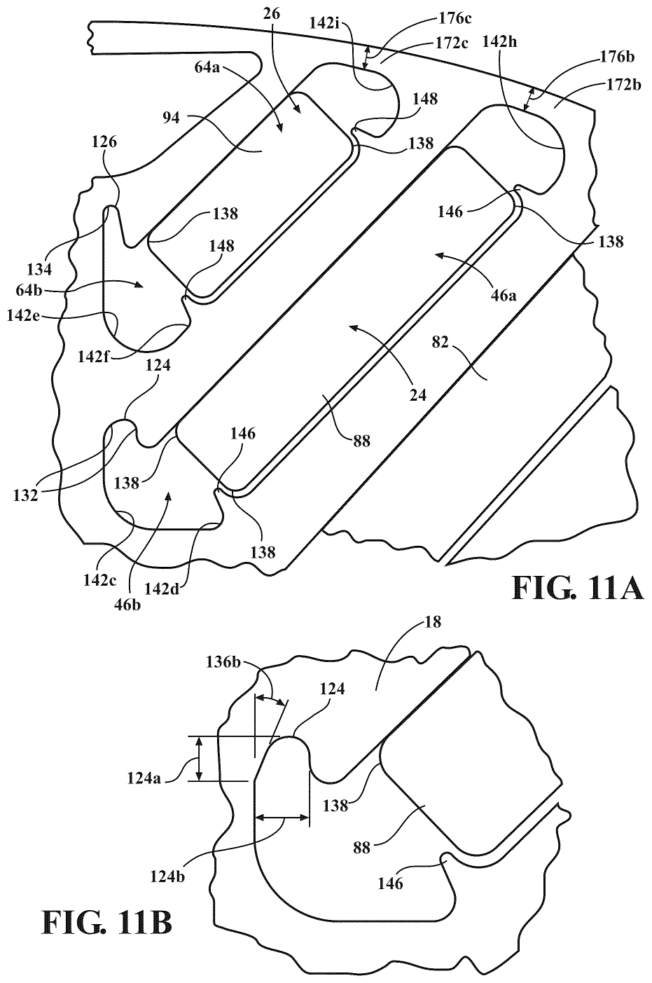

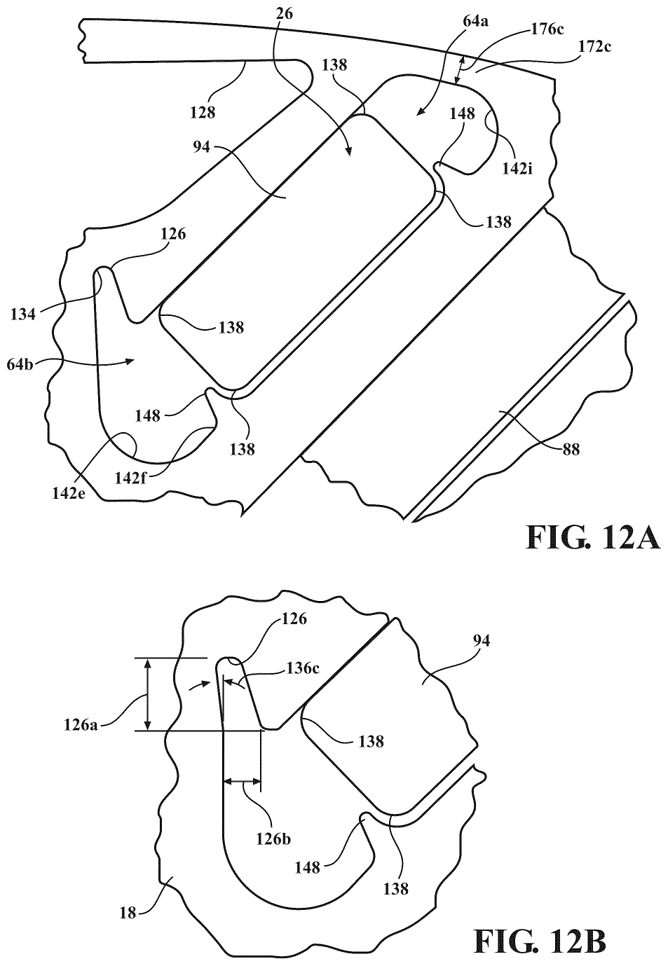

Each recess 122,124,126 is located at an angle 136a, 136b, 136c relative to the center point 120. In the embodiment, shown in FIGS. 7-14, the angles 136a, 136b, 136c of the recesses 122, 124,126 are close to zero degrees, or slightly negative, to facilitate blocking leakage flux in the radial ribs 150a, 150b, 150c of the rotor 18. The radial ribs 150a, 150b, 150c are located between the tail portions 28b,46b,64b of the pockets 22,24,26. As shown in FIG. 10B, the angle 136a is positive. As shown in FIG. 11B, the angle 136b is positive. As shown in FIG. 12B, the angle 136c is negative.

As previously mentioned, the permanent magnets 82,88,94 do not occupy the entire wing portions 28a,46a,64a of the pockets 22,24,26, respectively. The shape of the pockets 22,24,26 and the shape of the magnets 82,88,94 results in a portion of each of the pockets 22,24,26 being occupied by the magnets 82,88,94, respectively, and other portions of each of the pockets 22,24,26 being unoccupied by the magnets 82,88,94. The portion of the pockets 22,24,26 being occupied by the magnets 82,88,94 is a PM-to-barrier fill factor, or PM-to-barrier fill ratio. In the embodiment shown in FIGS. 7-14, the PM-to-barrier fill ratio of the first pocket 22 and first magnet 82 is 0.6-0.75, the PM-to-barrier fill ratio of the second pocket 24 and first magnet 88 is 0.55-0.7, the PM-to-barrier fill ratio of the third pocket 26 and first magnet 94 is 0.5-0.65.

Similar to the previous embodiment, each of the pockets 22,24,26 in the embodiment shown in FIGS. 7-14 has a wing-to-tail length ratio. However, in this embodiment, the wing-to-tail length ratio is between 3.7-5.2.

Also similar to the previous embodiment, each of the wing portions 28a,46a,64a of the corresponding pockets 22,24,26 in the embodiment shown in FIGS. 7-14 includes a wing length-to-thickness ratio. The wing length-to-thickness ratio of the wing portions 28a,46a of the embodiment shown in FIGS. 7-14 is 4.5-5.8, and the wing length-to-thickness ratio of the wing portions 64a of the embodiment shown in FIGS. 7-14 is 2.5-3.5.

Additionally, each of the tail portions 28b,46b,64b of the corresponding pockets 22,24,26 in the embodiment shown in FIGS. 7-14 also includes a tail length-to-thickness ratio. The tail length-to-thickness ratio of the tail portions 28b of the embodiment shown in FIGS. 7-14 is 0.7-1.3, the tail length-to-thickness ratio of the tail portions 46b of the embodiment shown in FIGS. 7-14 is 0.9-1.5, and the tail length-to-thickness ratio of the tail portions 64b of the embodiment shown in FIGS. 7-14 is 0.3-0.7.

The pockets 22,24,26 in the embodiment shown in FIGS. 7-14 also include a PM-to-barrier wing length ratio, which in a similar manner to the first embodiment, is defined as the length of each wing portion 28a,46a,64a relative to the length of each permanent magnets 82,88,94 (i.e., the length of the permanent magnets 82,88,94 divided by the length of the corresponding wing portions 28a,46a,64a).

With regard to the first plurality of pockets 22, the PM-to-barrier wing length ratio of the length 84 of the permanent magnets 82 to the length 102 of the wing portion 28a is between 0.82-0.97.

With regard to the second plurality of pockets 24, the PM-to-barrier wing length ratio of the length 90 of the permanent magnets 88 to the length 108 of the wing portion 46a is between 0.76-0.91.

With regard to the second plurality of pockets 26, the PM-to-barrier wing length ratio of the length 96 of the permanent magnets 94 to the length 114 of the wing portion 64a is between 0.72-0.88.

The magnets 82,88,94 of each pocket 22,24,26 are offset from the outer diameter of the rotor 18 by shifting them inward within the rotor laminations 20. This is shown in FIG. 9, where the permanent magnets 82,88,94 are located at a corresponding distance 152a, 152b, 152c from the outer diameter of the rotor 18. The distance 152a is longer than the distance 152b, and the distance 152b is longer than the distance 152c, such that the magnets 82,88,94 are offset from one another. When the magnets 82,88,94 are offset in this manner, there are larger air pockets near the outer diameter of the rotor 18 which protect the edges of the magnets 82,88,94 closest to the air gap of the motor 10. This offset toward the inner diameter of the rotor 18 as well as curved surfaces, or magnet fillets 138 on each corner of the magnets 82,88,94 facilitate reducing demagnetization risk at extreme operating temperatures. When the motor 10 is operating under load, the magnets 82,88,94 are exposed to higher magnetic field intensity on the edges of the magnets 82,88,94 which may cause irreversible damage to the magnetic characteristic of the magnets 82,88,94. By shifting the magnets 82,88,94 to be further from the airgap between the stator 12 and the rotor 18 (i.e., closer to the inner diameter of the rotor 18), there is less demagnetization risk for the permanent magnets 82,88,94 especially on their edges. The magnets 82,88,94 of the present embodiment shown in FIGS. 7-14 having the magnet fillets 138 generally observe lower magnetic field intensity, compared to the magnets 82,88,94 of the rotor 18 shown in FIGS. 1-6, which have sharp corners, instead of the magnet fillets 138.

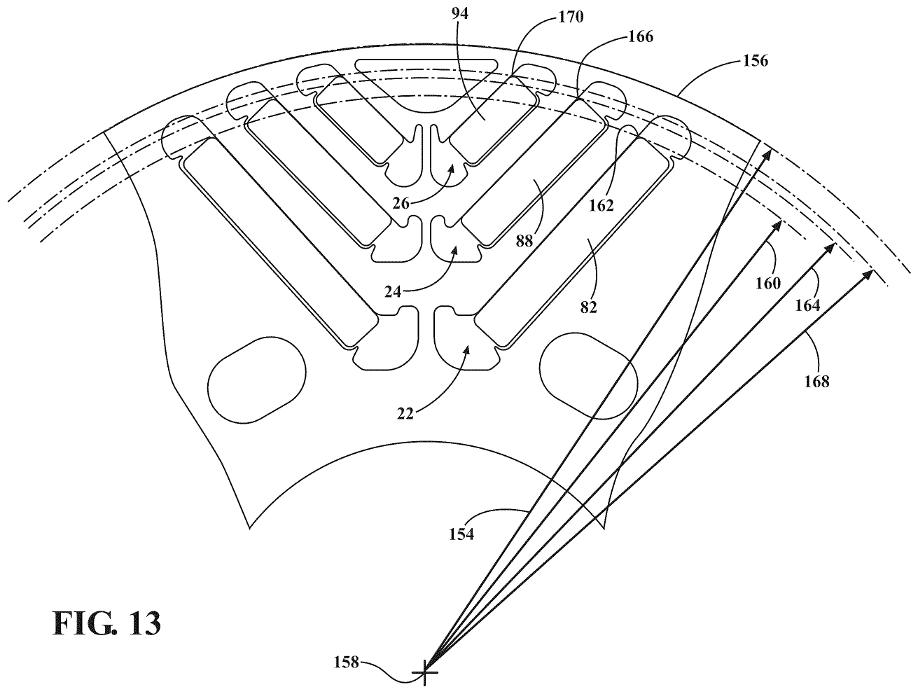

In addition to the magnets 82,88,94 of each pocket 22,24,26 being offset from the outer diameter of the rotor 18, the magnets 82,88,94 in the embodiment shown in FIGS. 7-14 also have a PM offset ratio, which is the ratio of the radius of the outer edge of each permanent magnet 82,88,94 relative to the radius of outer surface of the rotor 18. Referring to FIG. 13, a portion of the rotor 18 is shown, and the radius 154 is the distance of the outer surface 156 of the rotor 18 from the axis 158 of the rotor 18. The radius 160 is the distance from the axis 158 to the outer edge 162 of the permanent magnet 82 in the first pocket 22. The ratio of the radius 154 to the radius 160 is 0.89-0.93. More specifically, the length of the radius 160 is 0.89-0.93 times the length of the radius 154 (i.e., the length of the radius 154 multiplied by 0.89-0.93 is equal to the length of the radius 160). The radius 164 is the distance from the axis 158 to the outer edge 166 of the permanent magnet 88 in the second pocket 24. The ratio of the radius 154 to the radius 164 is 0.91-0.95. More specifically, the length of the radius 164 is 0.91-0.95 times the length of the radius 154 (i.e., the length of the radius 154 multiplied by 0.91-0.95 is equal to the length of the radius 164). The radius 168 is the distance from the axis 158 to the outer edge 170 of the permanent magnet 94 in the third pocket 26. The ratio of the radius 154 to the radius 168 is 0.93-0.97. More specifically, the length of the radius 168 is 0.93-0.97 times the length of the radius 154 (i.e., the length of the radius 154 multiplied by 0.93-0.97 is equal to the length of the radius 168).

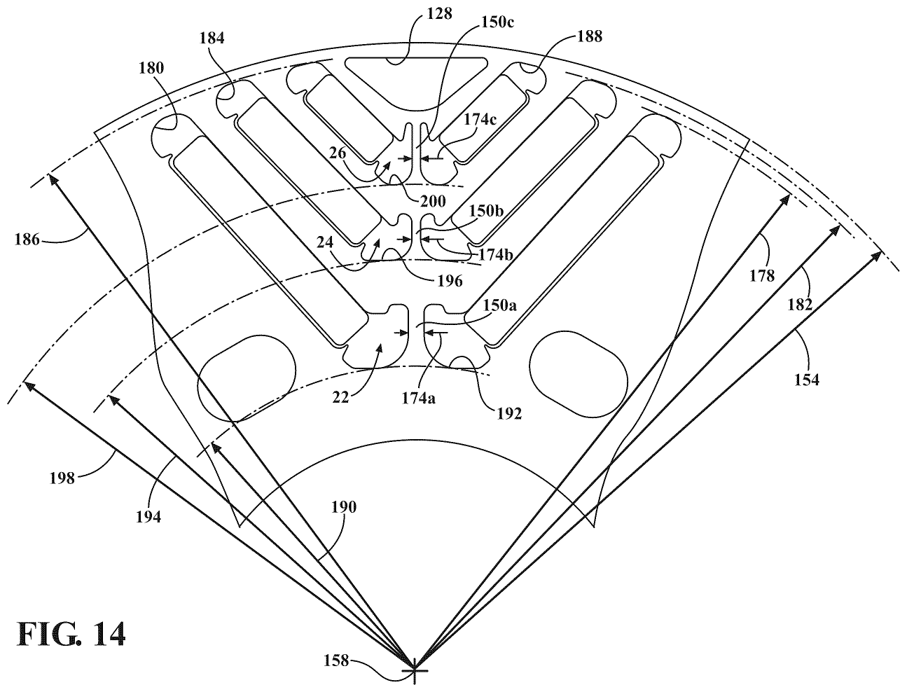

Each pocket 22,24,26 also has a barrier outer offset ratio, which is the ratio of the radius of the outer edge of each pocket 22,24,26 relative to the radius 154 of outer surface of the rotor 18. Referring to FIG. 14, the radius 178 is the distance from the axis 158 to the outer edge 180 of the first pocket 22. The ratio of the radius 154 to the radius 178 is 0.96-0.98. More specifically, the length of the radius 178 is 0.96-0.98 times the length of the radius 154 (i.e., the length of the radius 154 multiplied by 0.96-0.98 is equal to the length of the radius 178). The radius 182 is the distance from the axis 158 to the outer edge 184 of the second pocket 24. The ratio of the radius 154 to the radius 182 is 0.98-0.99. More specifically, the length of the radius 182 is 0.98-0.99 times the length of the radius 154 (i.e., the length of the radius 154 multiplied by 0.98-0.99 is equal to the length of the radius 182). The radius 186 is the distance from the axis 158 to the outer edge 188 of the third pocket 26. The ratio of the radius 154 to the radius 186 is 0.98-0.99. More specifically, the length of the radius 186 is 0.98-0.99 times the length of the radius 154 (i.e., the length of the radius 154 multiplied by 0.98-0.99 is equal to the length of the radius 186).

Each pocket 22,24,26 also has a barrier inner offset ratio, which is the ratio of the radius of the inner edge of each pocket 22,24,26 relative to the radius 154 of outer surface of the rotor 18. Referring again to FIG. 14, the radius 190 is the distance from the axis 158 to the inner edge 192 of the first pocket 22. The ratio of the radius 154 to the radius 190 is 0.4-0.5. More specifically, the length of the radius 190 is 0.4-0.5 times the length of the radius 154 (i.e., the length of the radius 154 multiplied by 0.4-0.5 is equal to the length of the radius 190). The radius 194 is the distance from the axis 158 to the inner edge 196 of the second pocket 24. The ratio of the radius 154 to the radius 194 is 0.6-0.7. More specifically, the length of the radius 194 is 0.6-0.7 times the length of the radius 154 (i.e., the length of the radius 154 multiplied by 0.6-0.7 is equal to the length of the radius 194). The radius 198 is the distance from the axis 158 to the inner edge 200 of the third pocket 26. The ratio of the radius 154 to the radius 198 is 0.7-0.8. More specifically, the length of the radius 198 is 0.7-0.8 times the length of the radius 154 (i.e., the length of the radius 154 multiplied by 0.7-0.8 is equal to the length of the radius 198).

The rotor 18 shown in FIGS. 7-14 also includes an outer pocket 128 which is unoccupied by a permanent magnet. The outer pocket 128 functions as a minor flux barrier and is located closer to the outer diameter of the rotor 18 compared to the other pockets 22,24,26. The shape of the outer pocket 128 is not limited to what is shown in FIGS. 7-14, but may be other shapes such as, but not limited to, trapezoidal, rectangular, triangular, elliptical, etc. Depending on the desired design and functionality, shape of the outer pocket 128 may be changed accordingly. The use of the outer pocket 128 reduces the overall mass of the rotor 18, resulting in less structural stress on the other pockets 22,24,26 and radial ribs 150a, 150b, 150c closer to the inner diameter of the rotor 18. A reduction in the overall mass of the rotor 18 reduces the inertia of the rotor 18 and decreases the mechanical losses. In addition to the radial ribs 150a, 150b, 150c, the rotor 18 also includes the tangential ribs 172a, 172b, 172c (similar to the previous embodiment), which are the areas of the laminations 20 between the wing portions 28a,46a,64a and the outer diameter of the rotor 18. By reducing the overall structural stress, smaller radial ribs 150a, 150b, 150c and tangential ribs 172a, 172b, 172c may be used which lowers the magnetic flux leakage and increases the overall performance of the motor 10, especially at higher speeds. In the embodiment shown in FIGS. 7-14 the width 174a of the radial rib 150a between the tail portions 28b is larger than the width 174b of the rib 150b between the tail portions 46b, and the width 174b of the rib 150b between the tail portions 46b is larger than the width 174c of the rib 150c between the tail portion 64b. The shape of the outer pocket 128 helps to guide the magnetic flux from the rotor 18 to the airgap and the windings of the stator 12, facilitating the flux to flow parallel to the magnets 82,88,94 and in between the magnets 82,88,94, and potentially increase the reluctance torque produced.

The radial ribs 150a, 150b, 150c of the embodiment shown in FIGS. 7-14 also have a radial rib width-to-height ratio, which is the width 174a, 174b, 174c of each radial rib 150a, 150b, 150c divided by the corresponding height. The radial rib width-to-height ratio of the radial rib 150a between the tail portions 28b is 0.28-0.36. The radial rib width-to-height ratio of the radial rib 150b between the tail portions 46b is 0.22-0.30. The radial rib width-to-height ratio of the radial rib 150c between the tail portions 64b is 0.18-0.24. The tangential ribs 172a, 172b, 172c of the embodiment shown in FIGS. 7-14 also have a tangential rib width-to-height ratio, which is the width 176a, 176b, 176c of each tangential rib 172a, 172b, 172c divided by the corresponding height. In this embodiment, the width 176a, 176b, 176c of each tangential rib 172a, 172b, 172c is different relative to one another. The tangential rib width-to-height ratio of the tangential rib 172a adjacent the wing portion 28a is 0.28-0.40. The tangential rib width-to-height ratio of the tangential rib 172b adjacent the wing portion 46a is 0.18-0.24. The tangential rib width-to-height ratio of the tangential rib 172c adjacent the wing portion 64a is 0.14-0.22.

In the embodiment shown in FIGS. 7-14, the pockets 22,24,26 are not parallel to each other. Each corresponding pocket angle 140a, 140b, 140c of the respective pocket 22,24,26 from the center point 120 is different from one other, within +5°. The difference in the pocket angles 140a, 140b, 140c provide benefits to the electromagnetic performance by boosting the reluctance torque and reducing the spatial harmonics in the airgap.

In the embodiment shown in FIGS. 7-14, the pockets 22,24,26 also include various curved surfaces 142a-142i, or barrier fillets. Several of the barrier fillets 142g, 142h, 142i are formed as part of an end of the wing portions 28a,46a,64a of the pockets 22,24,26, and several of the barrier fillets 142a, 142b, 142c, 142d, 142e, 142f, are formed as part of the tail portions 28b,46b,64b of the pockets 22,24,26. The barrier fillets 142a-142i are shaped accordingly to withstand the structural stresses resulting from centrifugal forces due to elevated rotational speeds. The radii of the barrier fillets 142a, 142c, 142e formed as part of the tail portions 28b,46b,64b of the pockets 22,24,26 closer to the inner diameter of the rotor 18 is significantly higher than that on the segments closest to the outer diameter of the rotor 18 in order to distribute the structural stress across a wider area. The shape of the pockets 22,24,26 in the areas of the barrier fillets 142a-142i provides a smooth magnetic circuit for linking the magnetic flux from the rotor 18 to the stator 12.

Integrally formed as part of the plurality of laminations 20 is a plurality of protrusions 144,146,148, each of which extend into a corresponding one of the plurality of pockets 22,24,26. The protrusions 144 of the pocket 22 are adjacent the magnet 82, the protrusions 146 of the pocket 24 are adjacent the magnet 88, and the protrusions 148 of the pocket 26 are adjacent the magnet 94. The magnets 82,88,94 are held in a desired location in the corresponding pocket 22,24,26 by the corresponding protrusions 144,146,148, preventing movement of the magnets 82,88,94. The protrusions 144,146,148 also facilitate a reduction in noise and vibration which could arise from the magnets 82,88,94 being loose inside the pockets 22,24,26.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. An apparatus, comprising:
a permanent magnet-assisted synchronous reluctance motor (PMa SynRM) structure of an electric motor, including:
a rotor having a plurality of poles, each of the plurality of poles further comprising:
a plurality of barriers integrally formed as part of the rotor; and
a plurality of permanent magnets, each of the plurality of permanent magnets disposed in a corresponding one of the plurality of barriers;
wherein the plurality of barriers and the plurality of permanent magnets provide desired magnetic flux distribution of the electric motor.

2. The apparatus of claim 1, the plurality of barriers further comprising:
a plurality of pockets, each of the plurality of pockets further comprising:
at least one wing portion, one of the plurality of permanent magnets disposed in the at least one wing portion; and
at least one tail portion adjacent the wing portion;
wherein the at least one wing portion is longer than the tail portion and the one of the plurality of magnets.

3. The apparatus of claim 2, the at least one wing portion further comprising:
a first wall portion having a first length;
a second wall portion having a second length, the second length being longer than the first length; and
a curved outer wall which is adjacent to and integrally formed with the first wall portion and the second wall portion;
wherein one of the plurality of permanent magnets is in contact with the first wall portion and the second wall portion.

4. The apparatus of claim 3, the at least one tail portion further comprising:
a first side wall having a first length;
a second side wall having a second length, where the second length is longer than the first length; and
an inner end wall, which is adjacent the first side wall and the second side wall;
wherein the first side wall is adjacent the first wall portion, and the second side wall is adjacent the second wall portion.

5. The apparatus of claim 4, wherein the first wall portion and the second wall portion are generally parallel to each other, and the first side wall and the second side wall are generally parallel to each other.

6. The apparatus of claim 2, each of the plurality of pockets further comprising:
a wing-to-tail length ratio, the wing-to-tail length ratio being the length of the at least one wing portion divided by the length of the at least one tail portion.

7. The apparatus of claim 6, each of the plurality of pockets further comprising:
a first plurality of pockets;
a second plurality of pockets; and
a third plurality of pockets, the second plurality of pockets is disposed between the first plurality of pockets and the third plurality of pockets;
wherein the wing-to-tail length ratio of the at least one wing portion of the first plurality of pockets is greater than the wing-to-tail length ratio of the at least one wing portion of the second plurality of pockets and greater than the wing-to-tail length ratio of the at least one wing portion of the third plurality of pockets.

8. The apparatus of claim 2, the first plurality of pockets further comprising:
a wing length-to-thickness ratio, the wing length-to-thickness ratio being the length of the at least one wing portion divided by the distance between the wall portions.

9. The apparatus of claim 8, each of the plurality of pockets further comprising:
a first plurality of pockets;
a second plurality of pockets; and
a third plurality of pockets, the second plurality of pockets is disposed between the first plurality of pockets and the third plurality of pockets;
wherein the wing length-to-thickness ratio of the at least one wing portion of the third plurality of pockets is less than the wing length-to-thickness ratio of the at least one wing portion of the second plurality of pockets, and the wing length-to-thickness ratio of the at least one wing portion of the second plurality of pockets is less than the wing length-to-thickness ratio of the at least one wing portion of the first plurality of pockets.

10. The apparatus of claim 2, the plurality of pockets further comprising:
a tail length to-thickness ratio, the tail length to-thickness ratio being the length of the at least one tail portion divided by the distance between side walls.

11. The apparatus of claim 10, each of the plurality of pockets further comprising:
a first plurality of pockets;
a second plurality of pockets; and
a third plurality of pockets, the second plurality of pockets is disposed between the first plurality of pockets and the third plurality of pockets;
wherein the tail length to-thickness ratio of the at least one wing portion of the third plurality of pockets is less than the tail length to-thickness ratio of the at least one wing portion of the first plurality of pockets and less than the tail length to-thickness of the at least one wing portion of the second plurality of pockets.

12. The apparatus of claim 2, each of the plurality of pockets further comprising:
a permanent magnet (PM)-to-barrier wing length ratio;
wherein the PM-to-barrier wing length ratio is the length of one of the permanent magnets divided by the length of the at least one wing portion.

13. The apparatus of claim 12, each of the plurality of pockets further comprising:
a first plurality of pockets;
a second plurality of pockets; and
a third plurality of pockets, the second plurality of pockets is disposed between the first plurality of pockets and the third plurality of pockets;
wherein the PM-to-barrier wing length ratio of each of the first of the plurality of pockets is greater than the PM-to-barrier wing length ratio of each of the second plurality of pockets and/or the PM-to-barrier wing length ratio of each of the third plurality of pockets.

14. The apparatus of claim 2, further comprising:
a plurality of radial ribs, each of the plurality of radial ribs are located between the at least one tail portion of two of the plurality of pockets;
wherein each of the plurality of radial ribs includes a radial rib width-to-height ratio, which is the width of each of the plurality of radial ribs divided by the corresponding height.

15. The apparatus of claim 14, the plurality of pockets further comprising:
a first plurality of pockets;
a second plurality of pockets; and
a third plurality of pockets, the second plurality of pockets is disposed between the first plurality of pockets and the third plurality of pockets;
wherein the radial rib width-to-height ratio of the one of the plurality of radial ribs between the tail portions of the first plurality of pockets is greater than the radial rib width-to-height ratio of one of the plurality of radial ribs between the tail portions of the second plurality of pockets, and the radial rib width-to-height ratio of the one of the plurality of radial ribs between the tail portions of the second plurality of pockets is greater than the radial rib width-to-height ratio of one of the plurality of radial ribs between the tail portions of the third plurality of pockets.

16. The apparatus of claim 2, further comprising:
a plurality of tangential ribs, each of the plurality of tangential ribs being located between the at least one wing portion and the outer diameter of the rotor;
wherein each of the plurality of tangential ribs includes a tangential rib width-to-height ratio, which is the width of each of the plurality of tangential ribs divided by the corresponding height.

17. The apparatus of claim 16, the plurality of pockets further comprising:
a first plurality of pockets;
a second plurality of pockets; and
a third plurality of pockets, the second plurality of pockets is disposed between the first plurality of pockets and the third plurality of pockets;
wherein the tangential rib width-to-height ratio of the one of the plurality of tangential ribs adjacent one of the first plurality of pockets is greater than tangential rib width-to-height ratio of the one of the plurality of tangential ribs adjacent one of the second plurality of pockets, and the tangential rib width-to-height ratio of the one of the plurality of tangential ribs adjacent the one of the second plurality of pockets is greater than tangential rib width-to-height ratio of one of the plurality of tangential ribs adjacent one of the third plurality of pockets.

18. The apparatus of claim 1, further comprising:
a permanent magnet (PM) offset ratio;
wherein the PM offset ratio is the ratio of the radius of the outer edge of each of the plurality of permanent magnets relative to the radius of the outer surface of the rotor.

19. The apparatus of claim 18, further comprising:
a first plurality of pockets;
a second plurality of pockets; and
a third plurality of pockets, the second plurality of pockets is disposed between the first plurality of pockets and the third plurality of pockets;
wherein the PM offset ratio of a first of the plurality of magnets located in a first of the first plurality of pockets is less than the PM offset ratio of a second of the plurality of magnets located in a first of the second plurality of pockets, and the PM offset ratio of the second of the plurality of magnets located in the first of the second plurality of pockets is less than the PM offset ratio of a third of the plurality of magnets located in one of the third plurality of pockets.

20. The apparatus of claim 1, further comprising:
a barrier outer offset ratio;
wherein the barrier outer offset ratio is the ratio of the radius of the outer edge of each of the plurality of pockets relative to the radius of the outer surface of the rotor.

21. The apparatus of claim 20, further comprising:
a first plurality of pockets;
a second plurality of pockets; and
a third plurality of pockets, the second plurality of pockets is disposed between the first plurality of pockets and the third plurality of pockets;
wherein the barrier outer offset ratio of each of the first plurality of pockets is less than the barrier outer offset ratio of each of the second plurality of pockets, and the barrier outer offset ratio of each of the second plurality of pockets is less than the barrier outer offset ratio of each of the third plurality of pockets.

22. The apparatus of claim 1, further comprising:
a barrier inner offset ratio;
wherein the barrier inner offset ratio is the ratio of the radius of the inner edge of each of the plurality of pockets relative to the radius of the outer surface of the rotor.

23. The apparatus of claim 22, further comprising:
a first plurality of pockets;
a second plurality of pockets; and
a third plurality of pockets, the second plurality of pockets is disposed between the first plurality of pockets and the third plurality of pockets;
wherein the barrier inner offset ratio of each of the first plurality of pockets is less than the barrier inner offset ratio of each of the second plurality of pockets and, the barrier inner offset ratio of each of the second plurality of pockets is less than the barrier inner offset ratio of the third plurality of pockets.

24. The apparatus of claim 2, each of the plurality of pockets further comprising:
a recess formed as part of the at least one tail portion, the recess being a flux leakage blocker; and
at least one fillet integrally formed as part of the recess, the at least one fillet distributing local stresses and preventing rotational magnetic fluxes;
wherein the recess of a first of the plurality of pockets has a height that is less than the recess of a second of the plurality of pockets, and the recess of a second of the plurality of pockets has a height that is less than the recess of a third of the plurality of pockets;
wherein the recess of the first of the plurality of pockets has a width that is wider than the recess of the second of the plurality of pockets, and the recess of the second of the plurality of pockets has a width that is wider than the recess of the third of the plurality of pockets.

25. The apparatus of claim 2, each of the plurality of pockets further comprising:
a plurality of barrier fillets integrally formed as part of the wing portion; and
a plurality of barrier fillets integrally formed as part of the tail portion;
wherein the plurality of barrier fillets integrally formed as part of the wing portion and the plurality of barrier fillets integrally formed as part of the tail portion are shaped to withstand the structural stresses resulting from centrifugal forces due to elevated rotational speeds of the rotor and facilitate a smooth magnetic circuit for linking the magnetic flux from the rotor to the stator.

26. The apparatus of claim 25, wherein the radii of each of the plurality of barrier fillets integrally formed as part of the at least one tail portion of each of the plurality of pockets closer to the inner diameter of the rotor is significantly higher than the radii of each of the plurality of barrier fillets integrally formed as part of the at least one tail portion of each of the plurality of pockets closest to the outer diameter of the rotor.

27. The apparatus of claim 2, each of the plurality of pockets further comprising:
a plurality of protrusions integrally formed as part of the rotor;
wherein each of the plurality of permanent magnets is held in position by two of the plurality of protrusions.

28. The apparatus of claim 2, further comprising:
an outer pocket which functions as a minor flux barrier;
wherein the outer pocket is located closer to the outer diameter of the rotor compared to the plurality of pockets.

29. The apparatus of claim 1, each of the plurality of permanent magnets further comprising:
a plurality of magnets fillets, each of the plurality of magnet fillets is integrally formed as part of a corresponding one of the plurality of permanent magnets;
wherein the plurality of magnet fillets distribute the magnetic field intensity near the corners of each of the plurality of permanent magnets.

30. The apparatus of claim 1, wherein each of the permanent magnets are located at an angle relative to one another.

31. The apparatus of claim 1, further comprising:
a PM-to-barrier fill ratio;
wherein the PM-to-barrier fill ratio is the portion of each of the plurality of pockets occupied by a corresponding one of the plurality of permanent magnets.

32. The apparatus of claim 31, further comprising
a first plurality of pockets;
a second plurality of pockets; and
a third plurality of pockets, the second plurality of pockets is disposed between the first plurality of pockets and the third plurality of pockets;
wherein the PM-to-barrier fill ratio of each of the first plurality of pockets is greater than the PM-to-barrier fill ratio of each of the second plurality of pockets, and the PM-to-barrier fill ratio of each of the second plurality of pockets is greater than the PM-to-barrier fill ratio of the third plurality of pockets.
